(19) United States
(12) Patent Application Publication
(10) Pub. No.: US 2025/0048526 A1
(43) Pub. Date: Feb. 6, 2025

(54) Discharge Device and Machine

(71) Applicant: Schunk Kohlenstofftechnik GmbH, Heuchelheim (DE)

(72) Inventors: Miroslav Tenev, Thuengen (DE); Johann Schlichtherle, Kaufbeuren (DE); Michael Voges, Zolling (DE); Juergen Spies, Langgoens (DE)

(21) Appl. No.: 18/788,908

(22) Filed: Jul. 30, 2024

(30) Foreign Application Priority Data
Aug. 1, 2023 (EP) 23189031.0

(51) Int. Cl. H05F 3/04

(52) U.S. Cl. CPC H05F 3/04

(57) ABSTRACT

A discharge device for discharging electrostatic charges from a shaft, in which the discharge device comprises a holder, a spring element disposed on the holder, and at least one conductor disposed on the spring element and running perpendicular to a longitudinal shaft axis. The conductor has a shaft contact portion for making contact with a circumferential contact area of a shaft circumference in such a manner that the shaft contact portion is tangential to the shaft circumference when in contact with the shaft circumference.

### CROSS-REFERENCE TO RELATED APPLICATION

This application claims priority to European Patent Application No. 23189031.0 filed Aug. 1, 2023, the disclosure of which is incorporated herein by reference in its entirety for all purposes.

### TECHNICAL FIELD

The invention relates to a discharge device for discharging electrostatic charges from a shaft. Furthermore, the invention relates to a machine comprising a discharge device.

### BACKGROUND

A discharge device of this kind is well known from the state of the art and is used for discharging electrostatic charges or electrical currents from a shaft of a machine, whereby an undesirable current flow via bearing points of the shaft and associated bearing damage can be avoided.

EP 3 044 840 B1 discloses a discharge device for discharging electrostatic charges from a shaft with a flexible conductor with a carbon fiber arrangement with at least two conductor portions disposed on a holder, running perpendicular to a longitudinal shaft axis and insulated from the holder, the conductor portions being configured to be connected to a ground conductor via their portion ends accommodated in the holder, the conductor portions each having a shaft contact portion, and the shaft contact portions together forming a set of contacts for making contact with two circumferential contact areas of a shaft circumference, which are disposed opposite each other in a shaft contact plane, in such a manner that the shaft contact portions are tangential to the shaft circumference when in contact with the shaft circumference. The portion ends are preferably connected to each other in one piece via a connecting portion, the connecting portion serving to connect to the ground conductor. Due to the flexible design of the conductor portions, the shaft contact portions are in contact with the shaft circumference in the circumferential contact areas with a contact force.

### SUMMARY

A disadvantage of the discharge device described above is that the contact force that can be generated by means of the flexible conductor is typically not high enough to achieve a sufficient discharge of electrostatic charges from the shaft via the discharge device, meaning that bearing damage cannot be reliably avoided despite the provision of the discharge device in a machine.

Hence, the object of the present invention is to propose a discharge device and a machine by means of which bearing damage can be reliably avoided.

This object is attained by a discharge device and a machine having the features described herein.

The discharge device according to the invention for discharging electrostatic charges from a shaft comprises a holder, a spring element disposed on the holder, and at least one conductor disposed on the spring element and running perpendicular to a longitudinal shaft axis, the conductor having a shaft contact portion for making contact with a circumferential contact area of a shaft circumference in such a manner that the shaft contact portion is tangential to the shaft circumference when in contact with the shaft circumference.

Accordingly, the invention provides that the discharge device comprises at least one conductor which is disposed on the holder via a spring element, preferably a single-piece spring element, which the discharge device also comprises, the provision of the spring element, in particular the associated possibility of forming the spring element completely independently of the conductor from a suitable material to achieve a desired or sufficiently high restoring force or contact force, making it possible for the shaft contact portion to be in contact with the shaft circumference in the circumferential contact area with a comparatively higher contact force, whereby a sufficient discharge of electrostatic charges or electrical currents from the shaft via the discharge device is always possible, with the effect that bearing damage can be reliably avoided. So the spring element is intended to form or generate a contact force with which the shaft contact portion is in contact with the shaft circumference in the circumferential contact area. The conductor can be rigid or flexible.

The holder can be made of an electrically non-conductive material, in particular a plastic material.

In a preferred embodiment of the discharge device, the discharge device may comprise two conductors disposed on the spring element and running perpendicular to the longitudinal shaft axis, the conductors being formed separately from each other, wherein the conductors may each have a shaft contact portion, wherein the shaft contact portions together may form a set of contacts for making contact with two circumferential contact areas of the shaft circumference, which are disposed opposite each other in a shaft contact plane, in such a manner that the shaft contact portions may be tangential to the shaft circumference when in contact with the shaft circumference. Due to the double design of the conductors or the shaft contact portions being in tangential contact with the shaft circumference in circumferential contact areas of the shaft circumference that are located essentially opposite each other, the discharge device functions independently of the direction of rotation. The discharge device can also comprise more than two conductors.

Furthermore, if the discharge device comprises two or more conductors, it can comprise a separate spring element for each conductor, in which case each conductor can be disposed on one of the spring elements. So the discharge device can then comprise two or more spring elements. However, the discharge device preferably comprises a single spring element, which enables a simple design of the discharge device.

Advantageously, the holder can be in the form of a plate, which enables a compact and cost-effective design of the discharge device. The holder or plate can have any suitable geometric shape. When the discharge device is disposed on a machine or a shaft, the plate or a plate plane can be perpendicular to the longitudinal shaft axis. The conductor or conductors can then extend in a plane parallel to the plate or the plate plane. So the shaft contact plane can then be parallel to the plate or the plate plane.

In a preferred embodiment of the discharge device, the holder can have a U-shaped cross section, in which case the holder can have two leg portions and a connecting portion connecting the leg portions, and the spring element can be disposed on the connecting portion. This embodiment of the discharge device is particularly advantageous if two conductors are provided. A design of the holder as a U-shaped plate enables a particularly compact and cost-effective design of the discharge device and a particularly space-saving installation of the discharge device. The connecting portion offers an advantageous option for attaching the spring element to the holder. When viewed from the front of the discharge device, each of the conductors can essentially extend across or in alignment with or along one of the leg portions. Furthermore, a hole can be formed in each leg portion, in which case the holes can serve to attach the discharge device to or dispose the discharge device on the machine or the shaft. Instead of a U-shape, the holder or the plate can also be V-shaped, rectangular or circular, for example. In general, holes for attaching the discharge device to or for disposing the discharge device on the machine or the shaft can be formed in the holder or the plate.

Advantageously, a space defined by the leg portions and the connecting portion can be formed for the shaft to pass through or can be configured to be passed through by the shaft or, when the discharge device is disposed on the machine or the shaft, can be passed through by the shaft, meaning the leg portions and the connecting portion can circumferentially surround part of the shaft, whereby the discharge device can be installed in a particularly space-saving manner. A radially inner side of the holder facing the shaft can then have a circular shape, at least in sections, i.e., be adapted to a circular cross-sectional shape of the shaft. If the holder or the plate has a rectangular or circular shape, a preferably circular passage formed in the holder can be passed through by the shaft. If a V-shape is provided for the plate, a space defined by two leg portions of the holder can be passed through by the shaft.

Advantageously, the holder can have a recessed area on the radially inner side of the holder in the area of the connecting portion, the recessed area serving to partially accommodate the spring element. The recessed area can partially accommodate the spring element disposed on the connecting portion and thus secure it against displacement, in particular along the connecting portion.

Advantageously, the spring element can be attached, preferably screwed, to the holder in a detachable manner. In this case, the spring element can also be easily replaced. The discharge device can comprise a screw means by means of which the spring element can be screwed to the holder. However, other types of attachment are also conceivable in addition to the detachable attachment, such as riveting or gluing.

Advantageously, the spring element can be attached to the holder by means of a fastening means of the discharge device, preferably the screw means, and the fastening means or screw means can further be provided for attaching a ground conductor to the spring element. The fastening means or screw means can then be used simultaneously to attach the spring element to the holder and to attach the ground conductor to the spring element, meaning no separate fastening means is required to attach the ground conductor to the spring element.

Advantageously, the spring element can be made of an electrically conductive material or a metal. The ground conductor can then be connected to the spring element so that the electrostatic charge can pass from the conductor or conductors to the ground conductor via the spring element. The ground conductor can be connected to the spring element using the fastening means or screw means, which can also be used to attach the spring element to the holder. Alternatively, the ground conductor may be connected to the spring element via a cable lug or a connection socket of the discharge device that is attached or connected to the spring element, or the ground conductor may be connected to the spring element by soldering. If the spring element is made of an electrically non-conductive material, the ground conductor can be connected to both conductors.

Advantageously, the spring element can have a base portion and at least one, preferably two, elastic portion, which is preferably arm-like and protrudes from the base portion, preferably at an angle, and to which the conductor can be attached. For attaching the spring element to the holder, the base portion, which can be disposed on the connecting portion essentially on a front of the discharge device, can be screwed to the connecting portion by means of the screw means, which can pass through a hole formed in the base portion and a hole formed in the connecting portion. The hole formed in the connecting portion can also be used, together with the holes formed in the leg portions, to dispose the discharge device on the machine or the shaft. If the discharge device comprises two conductors, the spring element can have two, preferably arm-like, elastic portions protruding from the base portion, preferably at an angle, and one of the conductors can be attached to each elastic portion. A force can be exerted on each conductor essentially independently of each other via the, preferably arm-like, spring arm portions.

Advantageously, the elastic portion or each elastic portion can have a fastening mount for attaching the conductor or one of the conductors. With an end portion of the conductor or end portions of the conductors, the conductor or conductors can then be inserted into the fastening mounts and attached therein, preferably by plastic deformation or crimping of the fastening mounts together with the end portions.

Advantageously, the spring element can be made of an elastic material, preferably spring sheet metal. By appropriate cutting and bending, the spring element can then be easily produced in one piece and with a desired geometry. A desired or sufficiently high contact force can easily result from a suitable choice of material, in particular the spring sheet metal, and/or a material thickness.

Advantageously, the conductor or the conductors can be attached to the spring element by plastic deformation, preferably crimping. This type of attachment is not only simple, but also ensures a secure attachment with good electrical contact between the spring element or the fastening sleeves and the conductor or the conductors. Attachment by means of a press connection or squeezing connection is also conceivable.

The conductor or the conductors can be made predominantly of carbon.

In a preferred embodiment of the discharge device, the conductor or the conductors can be made with or from carbon fibers. The carbon fibers can be embedded in a resin matrix. Furthermore, the carbon fibers can be provided with a coating of pyrolytic carbon, which can serve not only to densify a contact surface of the conductor or the conductors but also to form a shell supporting the carbon fibers. The coating can be produced, for example, by means of a CVI (Chemical Vapor Infiltration) process. The conductor or the conductors can then be made in particular with or from carbon fiber rods, carbon fiber mats, carbon fiber braids, carbon fiber films or the like. Instead of carbon fibers, a suitable metal, such as copper or brass, is also conceivable. Carbon-metal mixtures are also conceivable. Furthermore, any other suitable electrically conductive material is also conceivable. For example, it is conceivable for the conductor or the conductors to be made of a plastic filled with an electrically conductive material. In principle, the material from which the conductor or the conductors is/are made must be suitable for discharging the electrostatic charge.

Advantageously, the conductor or the conductors is/are elongated, preferably rod-shaped. The shaft contact portion or the shaft contact portions then has/have a comparatively large surface area, which can increase the discharge of the electrostatic charge.

Advantageously, if the discharge device comprises two conductors, the conductors or the longitudinal axes of the conductors can be disposed at an angle, i.e., non-parallel, relative to each other. However, a parallel configuration of the conductors would also be conceivable.

Advantageously, the discharge device can be configured in such a manner that, when viewed from the front of the discharge device, the holder or an outer side of the holder projects beyond the conductor or the conductors in a radial direction on all sides, meaning the conductor or the conductors does/do not project beyond the holder radially on the outside, whereby the discharge device can be made even more compact.

The machine according to the invention comprises a discharge device according to the invention. The machine may comprise a shaft.

### BRIEF DESCRIPTION OF THE FIGURES

A preferred embodiment of the invention is described in more detail below with reference to the accompanying drawings.

FIG. 1 is a front view of a discharge device.

FIG. 2 is a perspective front view of the discharge device obliquely from one side.

FIG. 3 is a sectional view of the discharge device along a line A-A shown in FIG. 1.

FIG. 4 is a perspective rear view of the discharge device obliquely from below.

FIG. 5 is a perspective rear view of the discharge device.

FIG. 6 is a perspective front view of the discharge device.

FIG. 7 is a bottom view of the discharge device.

FIG. 8 is a front view of the discharge device.

FIG. 9 is a side view of the discharge device.

FIG. 10 is a perspective front view of the discharge device from another angle.

FIG. 11 is a front view of a holder of the discharge device.

FIG. 12 is a perspective front view of the holder obliquely from one side.

FIG. 13 is a front view of a spring element of the discharge device.

FIG. 14 is a sectional view of the spring element along a line A-A shown in FIG. 13.

FIG. 15 is a bottom view of the spring element.

FIG. 16 is a partial view of the spring element.

### DETAILED DESCRIPTION

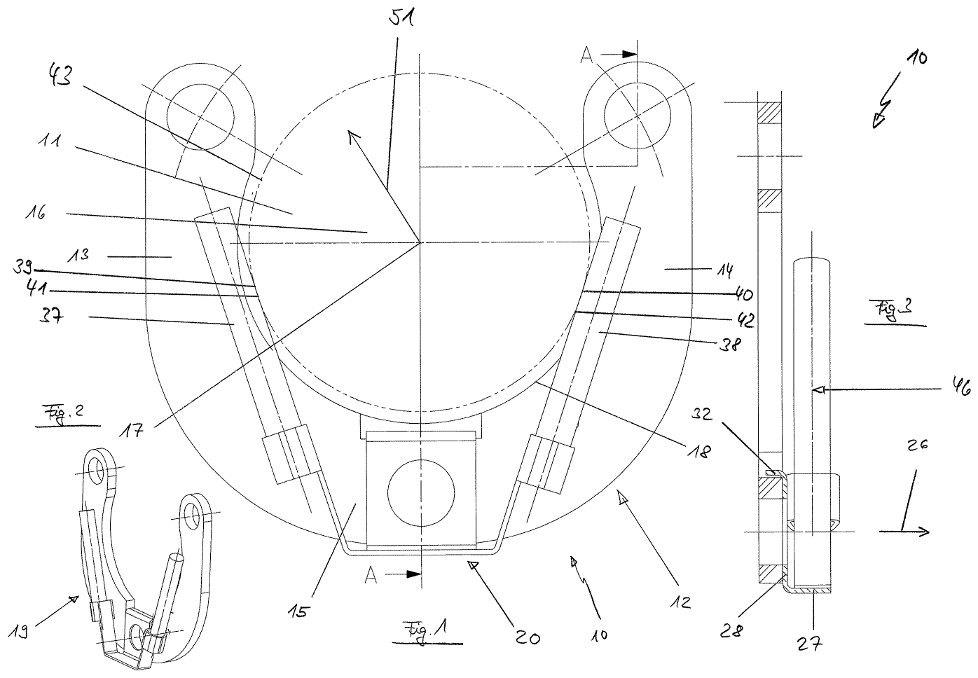

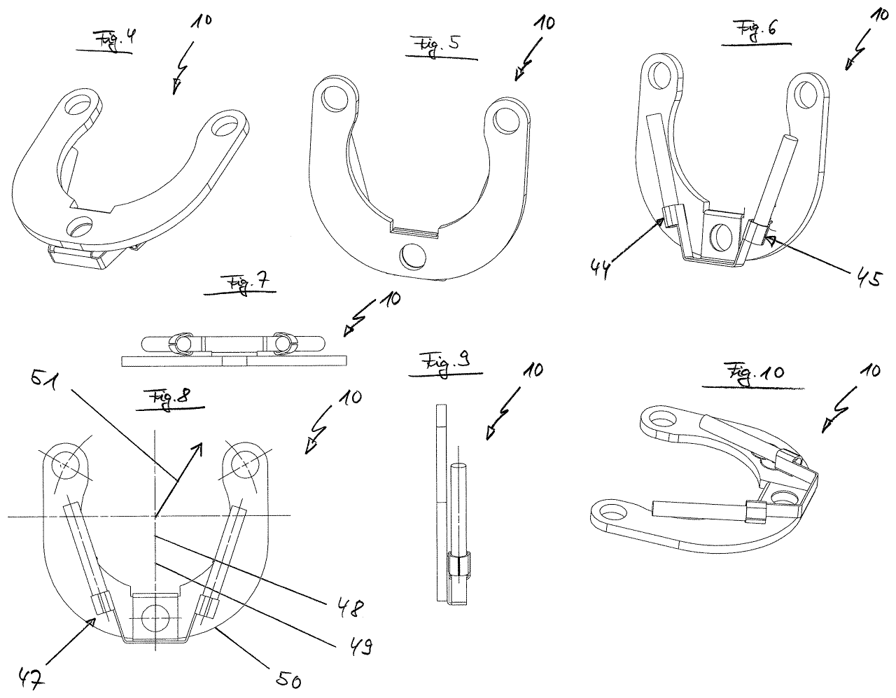

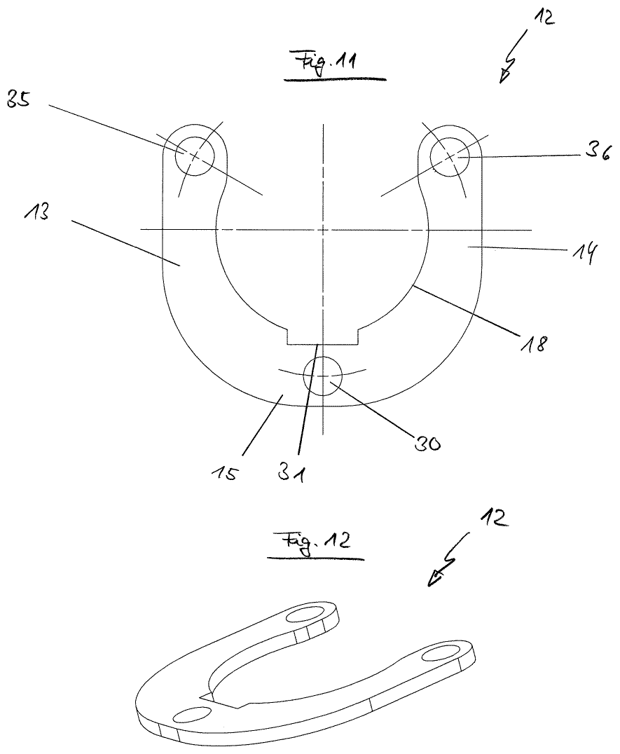

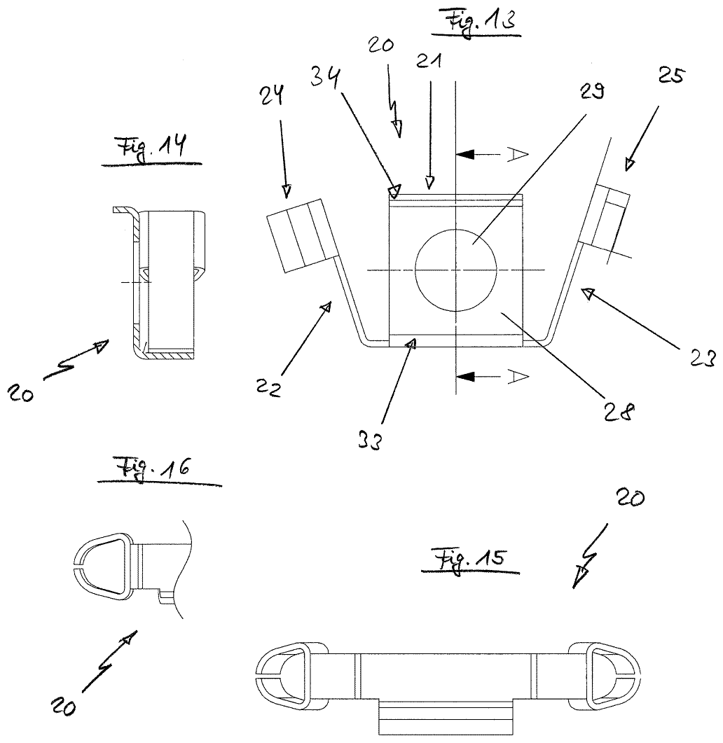

A combined view of FIGS. 1 to 16 shows a discharge device 10 for discharging electrostatic charges from a shaft 11, which is indicated merely by a dashed line in FIG. 1. The discharge device 10 comprises a holder 12 made of an electrically non-conductive material and formed by a plate having a U-shaped cross section, the holder 12 forming two leg portions 13, 14 and a connecting portion 15 connecting the leg portions 13, 14. The shaft 11 can pass through a space 16 defined by the leg portions 13, 14 and the connecting portion 15 when the holder 12 is perpendicular to a longitudinal shaft axis 17 when the discharge device 10 is disposed on the shaft 11 or a machine comprising the shaft 11, meaning the leg portions 13, 14 and the connecting portion 15 circumferentially surround part of the shaft 11. Part of a radially inner side 18 of the holder 12 has a circular shape. Furthermore, the discharge device 10 comprises a spring element 20, which is disposed on the holder 12 essentially at a front 19 of the discharge device 10 and is formed in one piece from electrically conductive spring sheet metal and forms a base portion 21 and two arm-like elastic portions 22, 23 protruding from the base portion 21 at an angle in opposite directions, the elastic portions 22, 23 having fastening mounts 24, 25 at their ends. Specifically, the elastic portions 22, 23 protrude from a first side portion 27 of the base portion 21, the first side portion 27 protruding over a center portion 28 of the base portion 21 in an axial direction 26 parallel to the longitudinal shaft axis 17, the elastic portions 22, 23 being molded onto the first side portion 27. To attach the spring element 20 to the holder 12, the center portion 28 disposed on the connecting portion 15 at the front 19 is screwed to the connecting portion 15 by means of a screw means (not shown), which passes through a hole 29 formed in the center portion 28 and a hole 30 formed in the connecting portion 15. The radially inner side 18 forms a recessed area 31 in the area of the connecting portion 15 in order to accommodate a second side portion 32 of the base portion 21, the second side portion 32 protruding over the center portion 28 in the direction opposite the axial direction 26, so that the spring element 20 is secured against displacement, in particular along the connecting portion 15. The first side portion 27 is molded onto the center portion 28 on one side 33 of the center portion 28, which is opposite a side 34 of the center portion 28 on which the second side portion 32 is molded onto the center portion 28. The base portion 21 has a Z-shaped cross section. A ground conductor (not shown) can additionally be attached or connected to the spring element 20 by means of the screw means. Furthermore, a hole 35, 36 is formed at the end of each leg portion 13, 14, the holes 35, 36 together with the hole 30 serving to attach the discharge device 10. Furthermore, the discharge device 10 comprises two rod-shaped conductors 37, 38, which are disposed on the spring element 20 and are predominantly made of carbon, with carbon fibers, and run perpendicular to the longitudinal shaft axis 17 when the discharge device 10 is disposed on the shaft 11 or the machine, the conductors 37, 38 each having a shaft contact portion 39, 40, the shaft contact portions 39, 40 together forming a set of contacts for making contact with two circumferential contact areas 41, 42 of a shaft circumference 43, which are disposed opposite each other, in such a manner that the shaft contact portions 39, 40 are tangential to the shaft circumference 43 when in contact with the shaft circumference 43. The shaft circumference 43 and the circumferential contact areas 41, 42 are also indicated by the dashed line as part of the dashed line. An end portion 44, 45 of each of the conductors 37, 38 is accommodated in one of the fastening sleeves 24, 25 and attached to the respective elastic portion 22, 23 by plastic deformation, i.e., crimping, of the fastening sleeve 24, 25 together with the end portion 44, 45. The conductors 37, 38 extend in a plane 46 parallel to the holder 12 on the front 19. In a front view of the discharge device 10, each of the conductors 37, 38 extends essentially across or in alignment with or along one of the leg portions 13, 14. The conductors 37, 38, which are disposed at an angle relative to each other, form a trapezoid 47 and extend across the holder 12 at a distance from the holder 12. An axis of symmetry 48 of the trapezoid 47 is aligned with an axis of symmetry 49 of the holder 12. In addition, a radially outer side 50 of the holder 12 protrudes beyond the conductors 37, 38 in a radial direction 51 perpendicular to the longitudinal shaft axis 17 on all sides in a front view.

What is claimed is:

1. A discharge device for discharging electrostatic charges from a shaft, the discharge device comprising a holder, a spring element disposed on the holder, and at least one conductor disposed on the spring element and running perpendicular to a longitudinal shaft axis, the conductor having a shaft contact portion for making contact with a circumferential contact are of a shaft circumference in such a manner that the shaft contact portion is tangential to the shaft circumference when in contact with the shaft circumference.

2. The discharge device according to claim 1, wherein the discharge device further comprises two conductors disposed on the spring element and running perpendicular to the longitudinal shaft axis, the conductors each having a shaft contact portion, the shaft contact portions together forming a set of contacts for making contact with two circumferential contact areas of the shaft circumference, which are disposed opposite each other in a shaft contact plane, in such a manner that the shaft contact portions are tangential to the shaft circumference when in contact with the shaft circumference.

3. The discharge device according to claim 1, wherein the holder is in the form of a plate.

4. The discharge device according to claim 1, wherein the holder has a U-shaped cross section, the holder having two leg portions and a connecting portion connecting the leg portions, the spring element being disposed on the connecting portion.

5. The discharge device according to claim 4, wherein a space defined by the leg portions and the connecting portion serves as a passage for the shaft.

6. The discharge device according to claim 4, wherein the holder has a recessed area on a radially inner side of the holder in the area of the connecting portion, the recessed area being configured to partially accommodate the spring element.

7. The discharge device according to claim 1, wherein the spring element is attached to the holder in a detachable manner.

8. The discharge device according to claim 1, wherein the spring element is attached to the holder by means of a fastening means of the discharge device, the fastening means further serving to attach a ground conductor to the spring element.

9. The discharge device according to claim 1, wherein the spring element is made of an electrically conductive material.

10. The discharge device according to claim 1, wherein the spring element has a base portion and at least one elastic portion, which protrudes from the base portion, the conductor being attached to the elastic portion.

11. The discharge device according to claim 10, wherein the elastic portion has a fastening mount for attaching the conductor.

12. The discharge device according to claim 1, wherein the spring element is made of an elastic material.

13. The discharge device according to claim 1, wherein the conductor is attached to the spring element by plastic deformation.

14. The discharge device according to claim 1, wherein the conductor comprises carbon fibers.

15. The discharge device according to claim 1, wherein the conductor is elongate.

16. The discharge device according to claim 2, wherein the conductors are disposed at an angle relative to each other.

17. A machine comprising a discharge device according to claim 1.
